(19) United States
(12) Patent Application Publication
(10) Pub. No.: US 2017/0318842 A1
(43) Pub. Date: Nov. 9, 2017

(54) Method for producing pasta with yogurt

(71) Applicant: Steven James Fillis, Cleveland, OH (US)

(72) Inventor: Steven James Fillis, Cleveland, OH (US)

(21) Appl. No.: 14/999,435

(22) Filed: May 4, 2016

(51) Int. Cl. A23L 7/109; A23C 9/123

(52) U.S. Cl. CPC A23L 7/109; A23C 9/123; A23V 2002/00

(57) ABSTRACT

A method is provided for the production of pasta with yogurt. Pasta made with yogurt can be prepared using dry yogurt powder or prepared yogurt. Such pastas are produced by carefully mixing the ingredients, extruding or pressing the mixture, then drying the formed pasta shapes at temperatures from about 130 degree F to about 200 degree F and at a low relative humidity sufficient to control the drying rate to a final moisture content of about 10 to 13 weight percent, wherein the pasta has, after processing and subsequent cooking, good color, texture, integrity and flavor.

### DESCRIPTION

### Field of the Invention

The present invention relates to method for the production of pasta with yogurt.

### Backgroud of the Invention

Yogurt is an extremely popular, healthy, and important food. Unfortunately in todays busy world, many people still neglect ingesting yogurt. The present invention fulfills that need by incorporating yogurt to one of the most popular food products in the world—pasta. Generally, it is prepared by forming a dough from pasta flour consisting of semolina, durum flour or other types of wheat flour, yogurt or yogurt powder, and water, extruding or pressing the dough into the form of any one of many popular shapes, and then carefully drying under controlled temperature and humidity conditions.

Efforts have been made for making modified pastas. In U.S. Pat. No. 5,945,144, Calcium fortified pasta and process of making is described.

Other efforts have been made for preparing modified pasta. In U.S. Pat. No. 5,508,053, a Method for producing vegetable pasta is described.

None of the prior efforts describes the pasta yogurt composition method of the present invention.

### SUMMARY OF THE INVENTION

Accordingly, the present invention is directed to a pasta with yogurt product which compromises water, wheat flour and yogurt, wherein said pasta with yogurt having the similar organoleptic properties, including taste, color, texture, firmness and compressibility of commercial pasta sold.

The present invention is also directed to the process for preparing the pasta wth yogurt product comprising mixing wheat flour, water and yogurt to form a mixture, extruding or pressing the mixture to prepare a desired pasta shape and drying the pasta substantially at controlled temperatures and relative humidity to obtain a pasta product containing a water content of at most about 13% by weight of the final product.

### DETAILED DESCRIPTION OF THE INVENTION

The present invention relates to a method of producing pasta with yogurt. Generally, the amount of yogurt solids is in the range of about 3 to about 17 weight percent of the dried pasta containing between about 10 to about 13 weight percent water.

In the first step of the present process, flour, yogurt or dry yogurt powder, and water are blended together to form a homogenous mixture or paste with a moisture content of about 28 to about 33 weight percent. The paste should be homogenous in order to produce a consistent and uniform pasta product. Conventional pasta mixers can be used for this blending step.

High quality, wheat-based flours with mixograph values above 6 and a falling number targeted at about 400 are preferred. The flour should be of the glutinous type and have a minimum average protein content of about 13 weight percent. Preferred wheat flours compromise 100 percent durum flours, 100 percent semolina flours, blends of durum or semolina flour and hard spring flour. Generally, flour having a granulation size such that about 98 percent minimum pass through a U.S. Standard no. 70 sieve are acceptable.

Sufficient yogurt or yogurt powder and water are added to, and blended with the flour using conventional pasta making equipment or mixers to produce desired paste. The water content of the paste should be adjusted to allow for the formation of suitable extrudates which will retain the desired shape until that shape is set or hardened in the initial portion of the drying process. Generally, water levels in the range of about 28 to about 33 weight percent are acceptable. When using prepared yogurt, a portion of the required water to form the homogenous paste will come from the prepared yogurt medium. Therefore, the final dried pasta has a yogurt solids content in the range of about 3 to about 17 weight percent based on the combined weight of the flour and solids.

Also, other additives or ingredients may, if desired, be added to the paste. Such additives include pH modifiers, salt, disodium phosphate, glyceryl monostearate, egg white powder, wheat gluten, whey solids and others. Such additives can be used to enhance flavor, nutritional value, or improve physical properties, but should be used in relatively low levels of less than about 2 weight percent of the total weight of the dried pasta.

Once the homogenous paste is formed, the paste is extruded or otherwise shaped using conventional pasta making techniques. For example, the homogenous paste can be forced through the holes of an extruder die or can be pressed betwen rollers to obtain the desired shape. Extrudates formed using an extruder die can be cut to the desired length. Shapes formed using rollers will be in the form of thin sheets which can then be cut into thin strips and to desired length before futher processing. All conventional pasta shapes can be used in the practice of this invention.

Once formed, the shaped pasta extrudates of this invention are dried under controlled conditions using high temperature and low relative humidity to produce a dried pasta. Of course, many time, temperature, and relative humidity conditions can be used so long the yogurt pasta is exposed to high temperatures of about 130 degree to about 200 degree F with a residence time depending on air temperature during the early portions of the drying cycle, the relative humidity remains about 40 to about 60 percent during the drying cycle, the final moisture content of the dried pasta is in the range of about 11 to about 13 weight percent, and the resulting dried pasta has good color, texture, integrity, and flavor.

As previously noted, the processof this invention can be implemented using conventional pasta making equipment, including conventional pasta drying ovens. The drying ovens must be capable of controlling the temperature and relative humidity to which the pasta shapes are exposed as a function of time.

Moreover, those skilled in the art will realize preferred drying profiles within these ranges can vary with other operational parameters including, scale of the manufacturing facility and actual equipment used.

After drying, the pasta is cooled and can be packaged.

The pasta made with yogurt product so produced, as described hereinabove, can then be utilized for eating by boiling the same in water and has organoleptic properties typical of commercial pasta sold.

This application is a continuation of U.S. provisional patent application No. U.S. 62/179,248 filed on May 4, 2015, which is hereby incorporated by reference.

That which is claimed is:

1. A method for producing pasta with yogurt containing about 3 to about 17 weight percent yogurt solids, said method comprising
(a) blending flour, prepared yogurt or dry yogurt powder and water to form a homogenous paste with a water content of about 28 to about 30 weight percent, wherein the flour has an average protein content of about 13 weight percent;
(b) extruding or pressing the homogenous paste to form desired pasta shape;
(c) and drying the shaped pasta at temperatures from about 130 degrees F to about 200 degrees F and at a low relative humidity of about 40 to about 60 percent during the drying cycle time sufficient to dry the pasta to a final moisture content of about 10 to 13 weight percent, wherein the pasta has, after processing and subsequent cooking, good color, texture, integrity and flavor.

2. A method as defined in claim 1, wherein the flour is selected from the type consisting of semolina flour, durum flour, hard spring flour, and mixtures thereof.
